(19) United States
(12) Patent Application Publication
(10) Pub. No.: US 2011/0218959 A1
(43) Pub. Date: Sep. 8, 2011

(54) SEARCH ENGINE MARKETING ANALYZER

(75) Inventors: Itai Levitan, Tel Aviv (IL); Amit Bluman, Alfei-Menashe (IL); Amir YARKONI, Moshav Beit Halevi (IL); Doron ASSAYAS, Tel Aviv (IL)

(73) Assignee: EDGE.BI LTD., Herzliya (IL)

(21) Appl. No.: 13/039,339

(22) Filed: Mar. 3, 2011

Related U.S. Application Data
(60) Provisional application No. 61/310,294, filed on Mar. 4, 2010.

(51) Int. Cl. G06F 17/30

(52) U.S. Cl. 707/602; 707/E17.005

(57) ABSTRACT

A method of processing search engine marketing (SEM) transaction data generated responsive to transactions associated with a search engine marketing campaign carried on the internet for an advertiser by at least one SEM channel, the method comprising: acquiring channel SEM transaction data generated by the at least one SEM channel responsive to the transactions; acquiring back office (BO) SEM transaction data generated by the advertiser responsive to the transactions; merging the SEM data and BO data associated with a same transaction into a merged record; storing the merged record in an OLAP database stored in a computer storage media storing computer executable instructions; and using the merged record in the OLAP database to analyze the transactions and generate an alert.

### CROSS-REFERENCES TO RELATED APPLICATIONS

The present application claims benefit under 35 U.S.C. §119(e) of U.S. Provisional Application 61/310,294 filed Mar. 4, 2010 the entire content of which is incorporated herein by reference.

### TECHNICAL FIELD

Embodiments of the invention relate to processing data generated by search engine marketing campaigns.

### BACKGROUND

Search engine marketing (SEM) comprises various methods by which an advertiser presents advertising material to a person, hereinafter also a “searcher”, on search engine result pages that the person reaches and/or accesses when the person performs a search for material of his or her interest on the web.

The behavior of searchers as they surf the web in performing their searches, for example, what links they follow and what sites they click on, and whether or not the advertising material generates desired results, (referred to as ‘conversions”—generally purchases), produces copious amounts of data relevant to assessing efficiencies of and providing a value for the advertising material. Often, the data is generated at a very high rate, and changes in a market targeted by the advertising material that are reflected in the data can warrant that the advertiser rapidly decide on, and make, changes in the advertising material and associated business strategies.

Various “channels” that provide facilities for SEM on their web page, such as Google Adwords, MSN, Yahoo, Facebook, and Bing provide their advertisers with methods and or reports for accessing marketing data for SEM campaigns that they carry for the advertisers.

### SUMMARY

An aspect of an embodiment of the invention, relates to providing a system for rapid processing of data relevant to a SEM campaign that integrates marketing data, hereinafter “SEM channel” data, generated by, and/or available from, a channel carrying the campaign with business information data, hereinafter referred to as “back-office data” (BO data), generally only available from and at the advertiser's business.

In an embodiment of the invention, SEM channel data and associated BO data are processed to configure the data, referred to as making the data “consistent”, to a common format for insertion as a record in a same On Line Transaction Processing (OLTP) database stored in a computer storage media storing computer executable instructions. An OLTP record comprising SEM channel data and BO data associated with a same web transaction, in accordance with an embodiment of the invention, is referred to as a “merged data record”. An OLTP database is a database for accruing and tracking data relevant to transactions, such as for example, sales transactions of a business, and is configured for relatively rapidly inserting, updating, and deleting, transaction data. SEM transaction data is data, comprising but not limited to SEM channel data or BO data, that is associated with transactions generated by a SEM advertising campaign.

Merged data records that associate SEM channel data with relevant BO data in accordance with an embodiment of the invention provide a new storage configuration for associating correlated data. The merged data improve speed with which SEM channel data can be analyzed to provide quality information to support enterprise decisions with respect to investments and usefulness of SEM campaigns.

Data records of transactions associated with an ad campaign are tagged with a feature that characterizes them independent of a channel in which the transactions occur. The characteristic feature, hereinafter referred to as a “meta-theme”, is used as a criteria for grouping, also referred to as “aggregating”, data records of transactions independent of channels in which they occur.

In an embodiment of the invention, merged data records tagged with meta-themes are adapted for and stored in an On Line Analytical Processing (OLAP) database, optionally configured as an OLAP cube stored in a computer storage media storing computer executable instructions for analyzing data in the OLAP cube and presenting the results of analysis of the data. An OLAP database is typically a read only database configured for relatively rapid retrieval of data as a function of relationships, defined by dimensions, between the data. In an OLAP database, a dimension is a variable as a function of which a parameter or parameters characterizing data in the OLAP database may vary. For example, time may be considered a “dimension”, and sales a parameter that is a function of time, e.g. “per quarter”. A variable may be both a dimension and an aggregator (a parameter that characterizes data that may be used to group data). For example, time in the example given above is used as an aggregator, because it is used to group sales by quarter. It is also used as a dimension, because time in quarters is used as a variable by which to track sales. The OLAP database provides a user, generally an advertiser or person functioning on behalf of the advertiser, with enhanced ability to rapidly provide accurate, multivariate analysis of her SEM information. Hereinafter, a user or an advertiser is generically referred to as an “advertiser”.

### BRIEF DESCRIPTION OF FIGURES

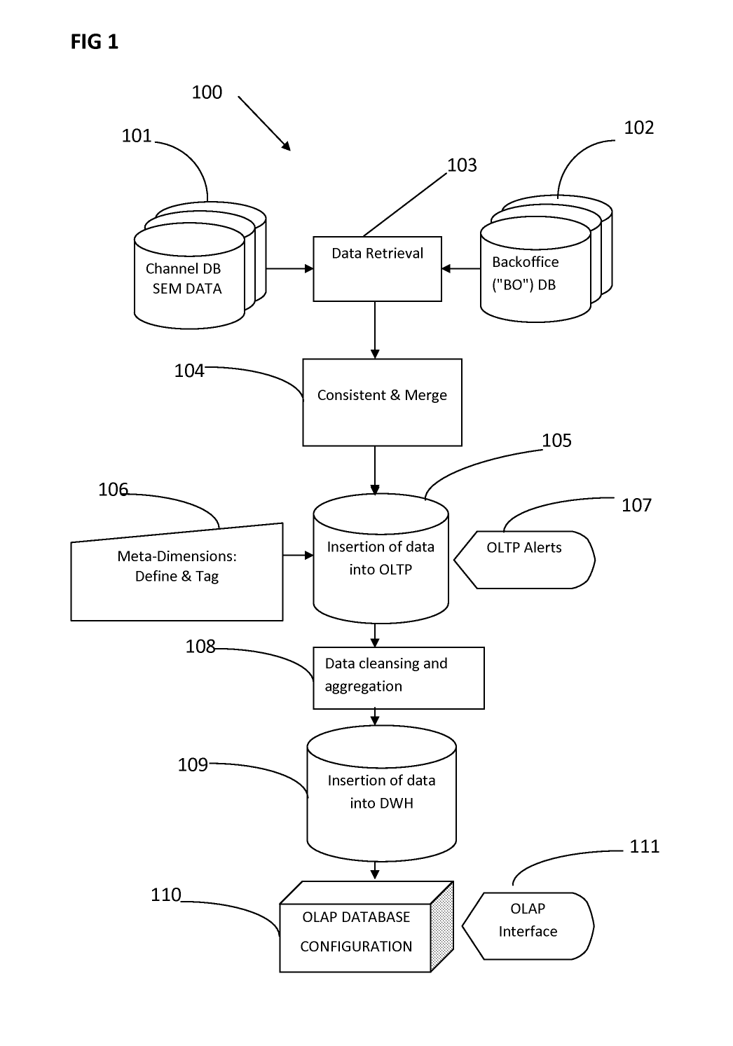

Non-limiting examples of embodiments of the invention are described below with reference to a FIG. 1 attached hereto, which shows a flow diagram of a process for generating and using an OLAP database, in accordance with an embodiment of the invention.

### DETAILED DESCRIPTION

FIG. 1 shows a flow diagram 100 of a process for generating an OLAP database, in accordance with an embodiment of the invention.

In a block 101, SEM data is generated by an advertiser's ad campaign in SEM channels that carry the campaign.

In a block 102 data associated with the ad campaign carried by the SEM channels, such as customer relations management data, shipping and inventory data for ordered items, etc, referred to as back office (BO) data is generated by the advertiser.

In a block 103, the SEM data and BO data are retrieved from the channels and the advertiser's “back office” respectively.

In a block 104, the retrieved SEM and BO data is optionally processed so that the data is consistent with storage formats of an On Line Transaction Processor (OLTP) data base stored in a computer storage media and SEM and advertiser BO data associated with a same transaction are merged to form a merged data record for the transaction.

Optionally, in a block 105, merged data records are stored into the OLTP database. It is noted that the OLTP database may comprise a plurality of component databases and data comprised in a same merged data record may be stored in different component databases of the OLTP database. Data in the OLTP database is indexed to provide relatively rapid data insertion and manipulation at a granular, non-aggregated, level at which the data is acquired.

Optionally, in a block 106, the advertiser defines parameters, i.e. “meta-themes” that characterize merged records of transactions stored in the OLTP database independent of the SEM channels associated with the transactions, and associates, “tags”, the merged records with appropriate meta-themes.

For example, if a given advertiser's text ad on Google offers a coupon for a new museum exhibition, and the advertiser's image or banner ad on Facebook offers a coupon in a similar manner, then the advertiser may define a new meta-theme referred to as a “museum coupon” and then tags each of the transaction records in the OLTP generated by the ads as a “museum coupon” record. Meta-themes are used to aggregate data and/or as dimensions for analysis of the data configured in an OLAP database, in accordance with an embodiment of the invention.

In a block 107, the advertiser defines and sets conditions for generating and receiving alerts as transaction data in the OLTP accumulates. An alert is a response to data accumulating in the OLTP that the advertiser determines warrants his or her special attention or intervention and optionally comprises a communication to at least one designated person that a data event has occurred that warrants special attention or intervention.

For example, assume a given advertiser is targeting the keyword “museum reviews”, which triggers ads in various SEM channels, and that the advertiser has pre-defined a drop of 50% or more in a number of clicks for any keyword or ad, as a trigger for raising an alert. If in a past week there has been a 50% drop in a number of clicks responsive to museum reviews in comparison to a number of clicks the keyword generated in a previous week, then an email or SMS alert message with an indication of the drop in the number of clicks responsive to “museum reviews” may be sent to a person designated by the advertiser.

Optionally, an alert comprises a recommendation message having at least one recommendation for an action to be undertaken in response to the data event that generated the alert. Optionally, the at least one recommendation comprises a prioritized list of recommendations for dealing with the data event.

For example, recommendations may be determined responsive to a return on investment (ROI) on a search engine marketing campaign as a function of a meta-theme. Assuming an advertiser runs an ad campaign with first and second ad groups associated with first and second different but related meta-themes, the advertiser might stipulate that if the ROI on the first group falls below X % and if the ROI on the second group falls below Y %, a recommendation should be made that the cost per click for the group should be reduced by Z %. And if the ROI for the both groups simultaneously falls below X % a recommendation should be provided and ranked that first one of the groups should be abandoned and that second, if following a recommended period of time the second ad group does not provide an acceptable ROI, the second group should be abandoned.

In a block 108 the data is cleansed in order to correct or remove corrupt or inaccurate data records from the OLTP. The cleansed data is aggregated at various granularity resolutions of desired variables to configure it for OLAP analysis and querying. (see blocks 110 and 111).

In a block 109, the cleansed and aggregated data is stored in a data warehouse (DWH). And in a block 110, the data in the data warehouse is configured as an OLAP data base and made available to an advertiser for performing analysis and ad-hoc queries of transaction data.

In a block 111 the advertiser optionally interfaces with a computer storage media in which the OLAP is stored to access the OLAP data base and view and explore transaction data stored therein from any of a multiplicity of different views and granularity resolutions. The advertiser may analyze the data using computer executable algorithms stored in the computer storage media which stores the OLAP and/or in a computer used to access the computer storage media optionally, to determine and anticipate marketing trends, opportunities and dangers. If an alert comprising a recommendation has been received by the advertiser, the advertiser may access the OLAP data base to review the recommendations and optionally the basis for recommendations and/or if the recommendations are prioritized reasons for determining the priorities of the recommendations.

For example, the advertiser may interface the OLAP data in a view that shows a meta-theme of “museum coupon” (associating the group of ads that relate to the museum coupon offering) where the ads associated with the meta-theme target Germany, US and other countries and are aggregated by country. The OLAP generated view shows the advertiser that the meta-theme is generating a high average advertiser value in Germany and the US, but low advertiser values in other countries (“losing countries”). This is an “insight” that the advertiser may use advertiser to remove or modify the ads relating to losing countries.

By way of another example, in block 111 the advertiser may view and analyze, the merged data associated with “museum coupon” as a meta-theme, viewing, for instance, the aggregated advertising cost of the ads along with income generated through the museum coupon theme. Note that in this example, the advertising cost data was originally retrieved from the Channel DB SEM data (block 101) and the income data was originally retrieved from the Client BO (block 102).

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method of processing search engine marketing (SEM) transaction data generated responsive to transactions associated with a search engine marketing campaign carried on the internet for an advertiser by at least one SEM channel, the method comprising:
acquiring channel SEM transaction data generated by the at least one SEM channel responsive to the transactions;
acquiring back office (BO) SEM transaction data generated by the advertiser responsive to the transactions;
merging the SEM data and BO data associated with a same transaction into a merged record;
storing the merged record in an OLAP database stored in a computer storage media storing computer executable instructions; and
using the merged record in the OLAP database to analyze the transactions and generate an alert.

2. A method according to claim 1 and comprising generating at least one recommendation for undertaking an action associated with the alert.

3. A method according to claim 2 wherein the at least one recommendation comprises a plurality of recommendations.

4. A method according to claim 3 and comprising prioritizing the recommendations.

5. A method according to claim 1 and comprising tagging SEM transaction data with a feature that characterizes transactions independent of a channel in which the transactions occur.

6. A method according to claim 5 and aggregating the transaction data responsive to the feature.

7. A method according to claim 5 and analyzing the transaction data responsive to the feature as a dimension in the OLAP data base.

8. A method of storing search engine marketing (SEM) transaction data generated responsive to transactions associated with a search engine marketing campaign carried on the internet for an advertiser by at least one SEM channel, the method comprising:
acquiring back office (BO) SEM transaction data generated by the advertiser responsive to the transactions;
merging the SEM data and BO data associated with a same transaction into a merged record;
storing the merged record in an OLAP database stored in a computer storage media storing computer executable instructions.

9. A computer readable storage medium comprising an OLAP data base stored therein and having search engine marketing (SEM) transaction data stored in accordance with claim 8.
